(19) United States
(12) Patent Application Publication
(10) Pub. No.: US 2003/0233850 A1
(43) Pub. Date: Dec. 25, 2003

(54) Process for making glass bodies having refractive index gradients

(76) Inventors: Fikret Kirkbir, Los Angeles, CA (US); Natsuki Otani, Atsugi-shi (JP); Satyabrata Raychaudhuri, Thousand Oaks, CA (US)

Correspondence Address: SHEPPARD, MULLIN, RICHTER & HAMPTON LLP, 333 SOUTH HOPE STREET, 48TH FLOOR, LOS ANGELES, CA, 90071-1448, US

(21) Appl. No.: 10/370,087

(22) Filed: Feb. 18, 2003

Related U.S. Application Data
(63) Continuation-in-part of application No. 09/636,266, filed on Aug. 10, 2000, now abandoned.

(51) Int. Cl. C03B 37/016

(52) U.S. Cl. 65/395; 65/426

(57) ABSTRACT

A process is suited for producing cylindrical silica glass bodies having refractive index gradients. The process involves providing a cylindrical porous body having an initially uniform dopant distribution, heating the porous body in a halogen-containing atmosphere to produce a dopant gradient sufficient to produce a reduction in Δn of at least 20% from the center of the body to 90% of the distance from the edge of the body, and completely densifying the porous body at an elevated temperature to produce the glass body. The process is more cost-effective than those previously known, and allows for high reproducibility of the refractive index gradients of the bodies produced.

This is a continuation-in-part of application Ser. No. 09/636,266, filed Aug. 10, 2000.

### BACKGROUND OF THE INVENTION

This invention relates generally to processes for making SiO₂ glass bodies and, more particularly, to processes for making SiO₂ glass bodies having refractive index gradients.

Glass bodies having refractive index gradients can be used in the manufacture of, for example, multi-mode graded-index optical fibers and graded-index optical lenses. Long-haul voice and data transmission, local area networks, and fibers for residential applications all can benefit from the use of graded-index optical fibers. To be suitable for extensive commercial deployment, such fibers must be economical to make and easy to produce.

Cylindrical gradient-index glass bodies, such as those used in optical fibers, typically are produced by one of several chemical vapor deposition (CVD) methods at high temperatures (i.e., above 1,000° C.), in which a radial refractive index gradient is achieved by varying dopant concentration in the gas phase. Such methods are relatively complicated and expensive.

An alternative process is disclosed in U.S. Pat. No. 4,812,153 to Andrejco et al., in which a cylindrical porous body having uniform GeO₂ dopant dispersion first is manufactured by a CVD process, and then the dopant is controllably removed in a halogen-containing atmosphere to obtain a refractive index gradient. This process is not entirely satisfactory, because the deposition efficiencies of the CVD process are relatively low and the deposition rates are slow, leading to material losses and extended processing times. Furthermore, the process disclosed in Andrejco et al. is initiated by providing a preform having a radial density gradient. The density is highest at the preform center (the center being the line defined by the centers of the circular cross-sections of the cylindrical body) and radially decreases towards the outer edge of the preform. This density gradient exists because of a non-uniform porosity in the preform. During removal of GeO₂ dopant with halogen-containing atmosphere, this preform is partially densified at its outer edge and completely densified at its center. This preferential densification in the radial direction aids the development of a GeO₂ gradient in the preform. Because the preform does not completely densify at the center at temperatures lower than 1,250° C., the desired GeO₂ gradient can be obtained only within a limited temperature range of 1,250° C. to 1,350° C. Furthermore, reproducibility of the refractive index profile depends on the reproducibility of the density gradient of the initial preform, which is based on the porosity gradient of the preform, and of the density gradient that develops during the preferential densification of this preform. These additional factors make reproducibility of the refractive index profile more difficult to achieve. In addition, because the gas phase contains chlorine during the preferential densification stage, chlorine can be trapped in the solid phase, particularly at the center, causing a formation of bubbles or foaming. Therefore, a need exists for a simple, reliable, reproducible process by which porous bodies can be chemically treated at lower temperatures to yield bubble-free glasses having refractive index gradients, without the need to use either special preforms having density or porosity gradients, or preferential densification to produce such density gradients.

Sol-gel techniques for producing glass bodies are well known. These techniques generally are known to produce bodies having uniform density and porosity. Several sol-gel processing techniques previously have been proposed to obtain glass bodies having dopant gradients. Some of these techniques include leaching of dopants from wet gels during the liquid phase by a variety of leaching solutions. Such liquid-phase leaching processes are not entirely satisfactory, however, because they are unduly slow for large-diameter preforms having high dopant levels. In another known technique, a porous wet gel tube is controllably doped at the liquid phase while being rotated. The use of the rotating porous tube complicates manufacturing and increases processing time.

Another known sol-gel process produces optical fiber preforms having refractive index gradients by coating a substrate, layer by layer, using solutions having different GeO₂ concentrations. This process is not entirely satisfactory, however, because layer-by-layer coating is slow and particularly uneconomical to use when producing large preforms. In another known process, a porous SiO₂ glass body is doped by diffusion of GeCl₄ during the gas phase, and then the dopant gradient is produced by removal of GeCl₄ from the porous glass. However, with such gas-phase infiltration processes, it is difficult to achieve high GeO₂ levels and to control the resulting gradient profile.

It should be appreciated from the foregoing description that there remains a need for a cost-efficient process for preparing glass bodies having a desired refractive index gradient. The present invention fulfills this need and provides further advantages.

### SUMMARY OF THE INVENTION

The present invention resides in a process for producing a cylindrical glass body having a refractive index gradient by: providing a cylindrical porous body having an initially uniform dopant distribution; heating the cylindrical porous body in a halogen-containing atmosphere to produce a dopant gradient in the porous body sufficient to produce a refractive index gradient in the body, preferably to a temperature in the range of about 500° C. to about 1,200° C. and more preferably to a temperature in the range of about 800° C. to about 1,100° C., and completely densifying entire cylindrical porous body at an elevated temperature, preferably to a temperature in the range of about 1,200° C. to about 1,300° C. The glass body thus manufactured has a reduction in Δn of at least 20% between a center of the glass body and a location 90% of the radial distance from the center to an outer edge of the glass body.

In preferred aspects of the process, the cylindrical porous body is heated in an oxygen-containing atmosphere to remove hydrocarbons from the cylindrical porous body, preferably to a temperature in the range of about 100° C. to about 500° C. prior to heating the cylindrical porous body in a halogen-containing atmosphere. In another preferred aspect of the process, the cylindrical porous body is heated in a halogen- and oxygen-containing atmosphere to remove hydroxyl ions, preferably to a temperature in the range of about 500° C. to about 800° C., before heating the cylindrical porous body in a halogen-containing atmosphere to produce the dopant gradient In another aspect of the preferred process, the porous body is heated in an oxygen-containing atmosphere, preferably to a temperature in the range of about 1,000° C. to about 1,200° C., to remove halogen ions from it after heating it in a halogen-containing atmosphere to produce the dopant gradient and before completely densifying the entire cylindrical body at an elevated temperature.

The porous body preferably is provided using a sol-gel process, and it preferably comprises SiO₂. Preferably, the porous body incorporates GeO₂ as a dopant. Preferably, the porous body has a dopant concentration in the range of about 1% to about 50% by weight, and more preferably in the range of about 5% to about 30% by weight. The halogen-containing atmosphere preferably comprises a compound incorporating chlorine, such as chlorine gas.

In preferred aspects of the invention, the cylindrical glass body is characterized by a reduction in Δn of at least 30%, and more preferably 40%, between a center of the glass body and a location situated 90% of the distance from the center to an outer edge of the glass body.

A preferred aspect of the process for producing a cylindrical glass body incorporates: providing a porous body having an initially uniform distribution of about 20% by weight of GeO₂ using a sol-gel process; heating the cylindrical porous body in an oxygen-containing atmosphere to a temperature of about 500° C. to remove hydrocarbons from the cylindrical porous body; heating the cylindrical porous body in a halogen- and oxygen-containing atmosphere to a temperature of about 800° C. to remove hydroxyl ions from the cylindrical porous body, heating the cylindrical porous body in a halogen-containing atmosphere to a temperature of about 1,000° C. to produce a GeO₂ gradient in the cylindrical porous body; heating the cylindrical porous body in an oxygen-containing atmosphere to a temperature of about 1,100° C. to remove halogen ions from the porous body; and, completely densifying the entire cylindrical porous body at a temperature of about 1,300° C.

Other features and advantages of the present invention should become apparent from the following detailed description of the preferred process, which discloses by way of example the principles of the invention.

### DESCRIPTION OF THE DRAWINGS

FIG. 1 is a graphical representation of the radial refractive index gradient of a cylindrical glass body sintered according to the method described in Example 1, in which n_{SiO2} is the refractive index of the SiO₂, ( i.e., 1.4580), n is the refractive index of the GeO₂ doped body, and Δn is the refractive index difference between the two.

FIG. 2 is a graphical representation of the radial refractive index gradient of a glass body sintered according to the method described in Example 2, labeled as in FIG. 1.

FIG. 3 is a graphical representation of the radial refractive index gradient of a glass body sintered according to the method described in Example 3, labeled as in FIG. 1.

FIG. 4 is a graphical representation of the radial refractive index gradient of a glass body sintered according to the method described in Example 4, labeled as in FIG. 1.

FIG. 5 is a graphical representation of the radial refractive index gradient of a glass body sintered according to the method described in Example 5, labeled as in FIG. 1.

### DETAILED DESCRIPTION OF THE PREFERRED PROCESSES

This invention relates to a method for making cylindrical doped SiO₂ glass bodies having Δn reduction of at least 20%, more preferably at least 30%, and most preferably at least 40%, from the center of the glass body to 90% of the radius of the body, preferably using sol-gel preparation techniques. The invention provides improved cost-efficiency and reproducibility of the refractive index gradient by its use of gas-phase leaching of uniformly-doped, uniformly porous bodies, which is a faster and more controllable process than those used in the past. Articles having refractive index gradients thereby can be produced faster, more simply, and at lower processing temperatures. This leads to greater yields and more cost-efficient production.

In the method of the invention, porous, dry SiO₂ gel bodies having uniform dopant concentrations and uniform porosity preferably are manufactured using a sol-gel process, such as that disclosed in U.S. Pat. No. 5,254,508 to Kirkbir et al. (“the Kirkbir patent”), hereby incorporated by reference. This process involves gelation of liquid precursors in cylindrical molds at room temperatures and subsequent drying of the wet gel bodies. This yields dry porous SiO₂ bodies having uniform GeO₂ dopant distributions. The dopant concentration in these bodies should preferably be between about 1% and about 50%, and more preferably between about 5% and about 30%. If the dopant concentration is less than 1%, it can be difficult to obtain the desired numerical aperture and index gradient. If the dopant concentration is greater than 50%, the densification temperature drops, which can lead to difficulty processing the body. Also, at higher concentrations, the thermal expansion mismatch between GeO₂ and SiO₂ increases, which can lead to cracking of the body. In the examples presented below, the dopant concentrations were about 20%.

The porous bodies preferably are heated to a temperature of from about 100° C. to 500° C. in an oxygen-containing atmosphere to remove alkoxides formed during preparation and drying of the porous bodies. Next, the porous bodies preferably are heated to a temperature of from about 500° C. to 800° C. in a chlorine- and oxygen-containing atmosphere to remove OH. Though chlorine is preferred in these process stages, other halogens, such as bromine, iodine, and fluorine, or halogen-containing compounds, such as CCl₄ and SOCl₂, also can be used. Next, GeO₂ in the bodies is controllably removed radially by a chlorination process to produce final products with the desired refractive index gradient. Removal of the GeO₂ is achieved in a chlorine-helium gas mixture at a constant temperature from about 500° C. to 1,200° C., more preferably from about 800° C. to 1,100° C. During this process step, GeO₂ is selectively removed from the bodies, and the radial refractive index gradient is formed. The GeO₂ is removed by chlorination according to the reaction:

GeO₂+2 Cl₂→GeCl₄+O₂

The porous body has small pores and high tortuosity. The primary pore radius of sol-gel derived bodies typically is less than 20 nm. Therefore, the chlorine gas requires time to diffuse to the center of the article. Since the chemical reaction time is faster than the diffusion rate of chlorine, a GeO₂ concentration gradient develops. The refractive index at a point in the resulting body is directly related to the GeO₂ concentration at that point. Therefore, a gradient in the GeO₂ concentration produces a corresponding refractive index gradient.

In a particularly preferred form of the process, chlorine in the sol-gel body is removed by heating the body in an oxygen atmosphere at a temperature above 1,000° C. This avoids formation of bubbles and foaming in the glass body that could occur from any remaining chlorine ions rapidly decomposing into chlorine gas. Finally, the entire body is - completely densified at an elevated temperature, preferably from about 1,200° C. to 1,300° C., in an atmosphere having helium concentration over 99%, as described in the Kirkbir patent.

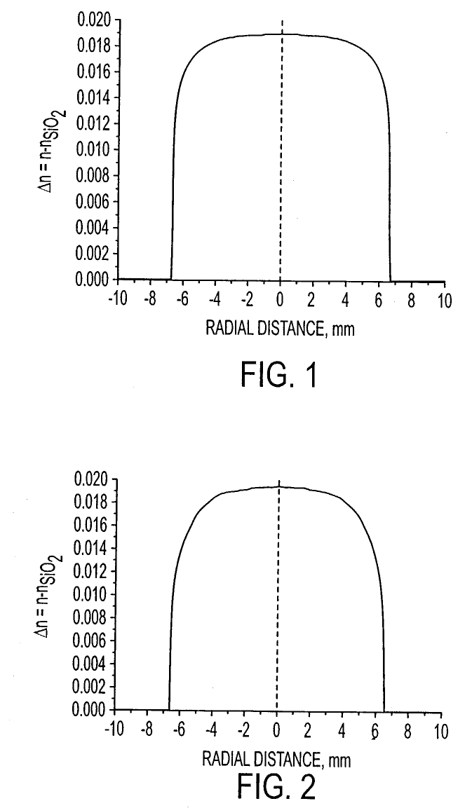

The key aspects of this invention now having been described, several examples will serve to further illustrate the utility of this process. Examples 1 to 6 of processes to form generally cylindrical glass bodies are described below. Example 1 illustrates use of a prior art process, resulting in formation of an inadequate refractive index gradient in the glass body. Examples 2 to 6 illustrate various aspects of the process of the present invention. FIGS. 1 to 6 illustrate refractive index gradients formed in the examples. Table 1 below provides, for Examples 1 to 5, the Δn values at the center (i.e., radius R=0), at R=90% of total radius, and at R=95% of total radius, as well as the % reduction in Δn at each of these locations. As is discussed below, such a determination was not possible for Example 6. The equipment used in preparation of the examples is known in the art. The porous bodies each are processed in a quartz tube sealed from the ambient atmosphere. The processing gases are supplied to this sealed tube by use of a gas control system, which includes regulators, flow controllers, and related equipment. The quartz tube is heated in a tubular furnace utilizing SiC resistance elements.

TABLE 1
Reduction in Δn. R is the normalized radial distance from the glass
center.

| Ex- | | | | | | |
|---|---|---|---|---|---|---|
| am- | Δn | | | % reduction in Δn | | |
| ple | R = 0% | R = 90% | R = 95% | R = 0% | R = 90% | R = 95% |
| 1 | 0.0190 | 0.0160 | 0.0150 | 0 | 16 | 21 |
| 2 | 0.0196 | 0.0140 | 0.0120 | 0 | 29 | 39 |
| 3 | 0.0193 | 0.0120 | 0.0102 | 0 | 38 | 47 |
| 4 | 0.0179 | 0.0106 | 0.0090 | 0 | 41 | 50 |
| 5 | 0.0177 | 0.0115 | 0.0106 | 0 | 35 | 40 |

### EXAMPLE 1

### Prior Art Process

This example illustrates preparation of a body without use of the halogenation treatment of the present invention. A cylindrical porous sol-gel body starting material having a uniform dopant concentration of about 20% GeO₂ was prepared as described in the Kirkbir patent. The sample was heated to 500° C. in an oxygen-containing atmosphere to remove hydrocarbons, and then it was heated to 800° C. in a chlorine and oxygen-containing atmosphere to remove OH. Finally, the chlorine in the sample was removed by heating the sample in an oxygen atmosphere to 1100° C., and then the entire body was completely densified at 1300° C. in a helium atmosphere.

The resulting glass body did not contain any visible bubbles. A refractive index gradient of the glass body was determined in the radial direction by a preform analyzer (P102 by York Technologies). The result is shown in FIG. 1. The zero base line corresponds to the refractive index of a pure SiO₂ glass, i.e. 1.4580. The increase in the glass refractive index is proportional to the dopant concentration. As indicated in Table 1, the glass body produced in Example 1 exhibits reduction in Δn of only 16% at R=90%. This result indicates that the refractive index gradient of this glass is substantially flat. GeO₂ was removed from the glass edges in negligible quantities. The method used in Example 1 is incapable of producing substantially larger refractive index gradients which are required by the industry to manufacture, for example, multi-mode graded-index optical fibers and graded-index optical lenses.

### EXAMPLE 2

A sample having a uniform 20% GeO₂ dopant concentration was prepared as in Example 1. The sample was heated to 500° C. in an oxygen-containing atmosphere to remove hydrocarbons, and then it was heated to 800° C. in a chlorine- and oxygen-containing atmosphere to remove OH. To achieve a GeO₂ concentration gradient, which in turn produces the refractive index gradient, the sample was heated to 1,000° C. in pure helium. Next, the helium atmosphere was exchanged for a 50%/50% chlorine/helium atmosphere and maintained at 1,000° C. for two hours. Finally, the chlorine in the sample was removed by heating the sample in an oxygen atmosphere to 1,100° C., and then the sample was completely densified at 1,300° C. in a helium atmosphere.

The resulting glass body did not contain any visible bubbles. The refractive index gradient of this glass body was determined by the method described in Example 1. The result, shown in FIG. 2, indicates that GeO₂ is removed from the edges forming a slight refractive index gradient. As indicated in Table 1, the glass body produced in Example 2 exhibits reduction in Δn of 29% at R=90%.

### EXAMPLE 3

A sample having a uniform 20% GeO₂ dopant concentration was prepared as in Example 2. In this case, however, during the chlorination step to create the concentration gradient, the sample was maintained in the chlorine/helium atmosphere at 1,000° C. for four, rather than two hours. The rest of the procedure followed was identical to that followed in Example 2.

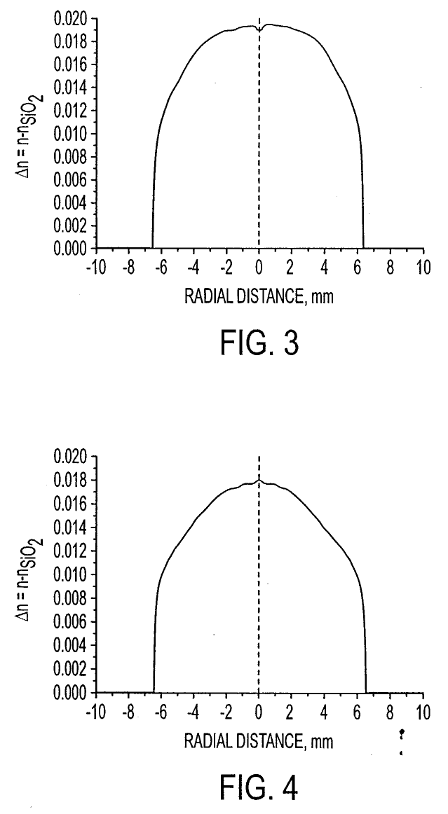

The resulting densified glass body did not contain any visible bubbles. The refractive index gradient of the glass body produced in this example is shown in FIG. 3. The GeO₂ removal from this glass body now is noticeable at the outer edges of the body. As indicated in Table 1, the glass body produced in Example 3 exhibits reduction in Δn of 38% at R=90%.

### EXAMPLE 4

Another sample having a uniform 20% GeO₂ dopant concentration was prepared, exactly as in Example 2. In this case, however, during the chlorination step to create the concentration gradient, the sample was maintained in the chlorine/helium atmosphere at 1,000° C. for eight, rather than two hours.

The resulting glass body did not contain any visible bubbles. The refractive index gradient obtained from this glass body is shown in FIG. 4. The GeO₂ removal from this glass body is considerable at its outer edges. As indicated in Table 1, the glass body produced in Example 4 exhibits reduction in Δn of 41% at R=90%. The results of this example, taken together with those of Examples 2 and 3, show that the effect of increasing the chlorination time is to increase the dopant removal, thus producing a larger refractive index gradient.

### EXAMPLE 5

A fifth sample having a uniform 20% GeO₂ dopant concentration was prepared, exactly as in Example 2. In this case, however, during the chlorination step to create the concentration gradient, the sample was maintained in a 100% chlorine gas atmosphere at 1,000° C. for four hours.

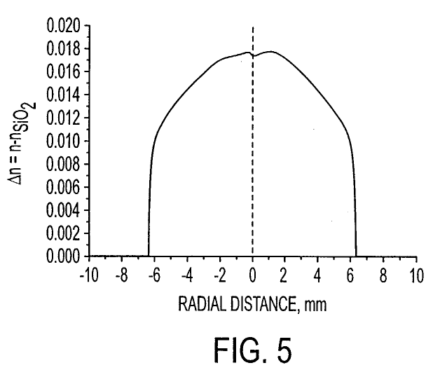

The resulting completely densified glass body did not contain any visible bubbles. The refractive index gradient obtained from this glass body is shown in FIG. 5. As indicated in Table 1, the glass body produced in Example 5 exhibits reduction in Δn of 35% at R=90%. The refractive index gradient of this body is greater than that of the glass obtained in Example 3, in which the body was kept in the 50% chlorine atmosphere for four hours. The results of this Example, taken together with those for Example 3, show that the effect of increasing the chlorine gas concentration is to increase the dopant removal, thus producing a larger refractive index gradient. The results of Examples 3, 4 and 5 indicate that the profile of the refractive index gradient can be controlled by varying chlorination time and chlorine gas concentration.

### EXAMPLE 6

A sixth sample having a uniform 20% GeO₂ dopant concentration was prepared, exactly as in Example 2. This time, however, during the chlorination step to create the concentration gradient, the sample was kept in a 50%/50% chlorine/helium atmosphere at 1,200° C. for four hours. Next, the chlorine in the sample was removed by heating the sample in an oxygen atmosphere at 1,200° C., and then the sample was completely densified at 1300° C. in a helium atmosphere. The resulting densified glass body had visible bubbles. Because of the bubbles, this glass would be unsuitable for use in fiber draw or high quality lens applications, and it also does not provide for a smooth refractive index profile. The results of Example 6 illustrate that a temperature of 1,200° C. during the chlorination step of the present invention is too high.

The above examples serve to demonstrate that selected combinations of temperature, time, and chlorine concentration can be used to achieve various refractive index gradient profiles of GeO₂ in the SiO₂ glass body, starting from a uniform dopant concentration and uniform density. These gradient profiles result in refractive index gradients in which the reduction in Δn at a distance 90% of that from the body center-to edge are greater than 20%. This level of refractive index gradient cannot be achieved using prior art processes.

Although the invention has been described in detail with reference only to the presently preferred process, those of ordinary skill in the art will appreciate that various modifications can be made without departing from the invention. Accordingly, the invention is defined only by the following claims.

We claim:

1. A process for producing a cylindrical glass body having a refractive index gradient, comprising:
providing a cylindrical porous body having an initially uniform dopant distribution;
heating the cylindrical porous body in a halogen-containing atmosphere to produce a dopant gradient in the porous body, the dopant gradient sufficient to produce a refractive index gradient index in the body such that glass body is characterized by a reduction in Δn of at least 20% between a center of the glass body and a location situated 90% of the distance from the center to an outer edge of the glass body; and
completely densifying the cylindrical porous body at an elevated temperature.

2. The process of claim 1, further comprising heating the cylindrical porous body in an oxygen-containing atmosphere to remove hydrocarbons from the porous body, before heating the cylindrical porous body in a halogen-containing atmosphere to produce the dopant gradient in the porous body.

3. The process of claim 2, wherein heating the cylindrical porous body in an oxygen-containing atmosphere to remove hydrocarbons from the cylindrical porous body comprises heating the cylindrical porous body to a temperature in the range of about 100° C. to about 500° C.

4. The process of claim 1, further comprising heating the cylindrical porous body in a halogen- and oxygen-containing atmosphere to remove hydroxyl ions from the porous body, before heating the cylindrical porous body in a halogen-containing atmosphere to produce the dopant gradient in the cylindrical porous body.

5. The process of claim 4, wherein heating the cylindrical porous body in a halogen- and oxygen-containing atmosphere to remove hydroxyl ions comprises heating the cylindrical porous body to a temperature in the range of about 500° C. to about 800° C.

6. The process of claim 1, wherein heating the cylindrical porous body in a halogen-containing atmosphere to produce the dopant gradient in the cylindrical porous body comprises heating the porous body to a temperature in the range of about 500° C. to about 1,200° C.

7. The process of claim 6, wherein heating the cylindrical porous body in a halogen-containing atmosphere to produce the dopant gradient in the cylindrical porous body comprises heating the cylindrical porous body to a temperature in the range of about 800° C. to about 1,100° C.

8. The process of claim 1, further comprising heating the cylindrical porous body in an oxygen-containing atmosphere to remove halogen ions from the cylindrical porous body, after heating the cylindrical porous body in a halogen-containing atmosphere to produce the dopant gradient in the cylindrical porous body, and before completely densifying the cylindrical porous body at an elevated temperature.

9. The process of claim 8, wherein heating the cylindrical porous body in an oxygen-containing atmosphere to remove halogen ions from the cylindrical porous body comprises heating the cylindrical porous body to a temperature in the range of about 1,000° C. to about 1,200° C.

10. The process of claim 1, wherein the elevated temperature is from about 1,200° C. to about 1,300° C.

11. The process of claim 1, wherein providing includes providing a cylindrical porous body using a sol-gel process.

12. The process of claim 1, wherein the cylindrical porous body comprises SiO₂.

13. The process of claim 1, wherein the dopant is GeO₂.

14. The process of claim 1, wherein providing includes providing a cylindrical porous body in which the concentration of dopant is in the range of about 1% to about 50% by weight.

15. The process of claim 14, wherein providing includes providing a cylindrical porous body in which the concentration of dopant is in the range of about 5% to about 30% by weight.

16. The process of claim 1, wherein the halogen-containing atmosphere comprises a compound incorporating chlorine.

17. The process of claim 1, wherein the halogen-containing atmosphere comprises chlorine gas.

18. The process of claim 1, wherein the cylindrical glass body is characterized by a reduction in Δn of at least 30% between a center of the cylindrical glass body and a location situated 90% of the distance from the center to an outer edge of the cylindrical glass body.

19. The process of claim 8, wherein the cylindrical glass body is characterized by a reduction in Δn of at least 40% between a center of the cylindrical glass body and a location situated 90% of the distance from the center to an outer edge of the cylindrical glass body.

20. A process for producing a cylindrical glass body, comprising:
providing a cylindrical porous body having an initially uniform distribution of about 20% by weight of GeO₂ using a sol-gel process;
heating the cylindrical porous body in an oxygen-containing atmosphere to a temperature of about 500° C. to remove hydrocarbons from the cylindrical porous body;
heating the cylindrical porous body in a halogen- and oxygen-containing atmosphere to a temperature of about 800° C. to remove hydroxyl ions from the cylindrical porous body;
heating the cylindrical porous body in a halogen-containing atmosphere to a temperature of about 1,000° C. to produce a GeO₂ gradient in the cylindrical porous body;
heating the cylindrical porous body in an oxygen-containing atmosphere to a temperature of about 1,100° C. to remove halogen ions from the cylindrical porous body; and completely densifying the cylindrical porous body at a temperature of about 1,300° C.
